(19) United States
(12) Patent Application Publication
(10) Pub. No.: US 2015/0090702 A1
(43) Pub. Date: Apr. 2, 2015

(54) LASER CUTTING DEVICE AND METHOD

(71) Applicant: LG CHEM, LTD., Seoul (KR)

(72) Inventors: Jin Ho BAN, Daejeon (KR); Chang Bum AHN, Daejeon (KR); Ki Hong MIN, Daejeon (KR); Ji Won PARK, Daejeon (KR); Myung Hoon KO, Daejeon (KR); Seung Ho NA, Daejeon (KR)

(73) Assignee: LG CHEM, LTD., Seoul (KR)

(21) Appl. No.: 14/566,207

(22) Filed: Dec. 10, 2014

Related U.S. Application Data
(63) Continuation of application No. PCT/KR2014/007052, filed on Jul. 31, 2014.

(30) Foreign Application Priority Data
Sep. 25, 2013 (KR) 10-2013-0114003

(51) Int. Cl. B23K 26/03; B23K 26/38; B23K 26/08

(52) U.S. Cl. CPC B23K 26/032; B23K 26/083; B23K 26/0869; B23K 26/38
USPC 219/121.81; 219/121.78; 219/121.82

(57) ABSTRACT

Provided is a laser cutting device and method which changes a cutting speed of a laser according to a difference between characteristics (absorption coefficients) of an object to be cut, so as to uniformly supply an energy of laser to the whole of the object, thereby preventing the object from being incompletely cut. A laser cutting device includes a database that stores information about a cutting pattern, a moving part that changes a location of a laser beam emitted to an object to be cut, a characteristic value input part that receives speed information from a user according to locations on the cutting pattern, and a control part that adjusts a moving speed of the laser beam by controlling the moving part according to the speed information from the characteristic value input part, and the information about the cutting pattern from the data base.

### CROSS-REFERENCE TO RELATED APPLICATIONS

This application claims priority to and the benefit of Korean Patent Application No. 10-2013-0114003 filed in the Korean Intellectual Property Office on Sep. 25, 2013, the entire contents of which are incorporated herein by reference.

### TECHNICAL FIELD

The present invention relates to a cutting device using a laser, and more particularly, to a laser cutting device and method which changes a cutting speed of a laser according to a difference between characteristics (absorption coefficients) of an object to be cut, so as to uniformly supply an energy of laser to the whole of the object, thereby preventing the object from being incompletely cut.

### BACKGROUND

Lasers are widely used not only in general industry fields such as the fields of cutting, shaping, and welding, but also in the fields of medical devices, optical communications, and computer industries. In particular, cutting devices using a laser are widely used to cut glass or metal.

However, typical cutting devices emit the same laser beam at the same speed even when an object to be cut has different characteristics according to regions thereof. Thus, the object may be abnormally cut in a part of the regions. As a result, the object may be incompletely cut.

Thus, according to embodiments of the present invention, even when an object to be cut includes regions having different characteristics, the object can be completely cut, allowing for the different characteristics.

### SUMMARY OF THE INVENTION

The present invention aims at providing a cutting device and method, which completely cuts an object even when the object includes regions having different characteristics.

An exemplary embodiment of the present invention, there is provided a laser cutting device including: a database that stores information about a cutting pattern; a moving part that changes a location of a laser beam emitted to an object to be cut; a characteristic value input part that receives speed information from a user according to locations on the cutting pattern; and a control part that adjusts a moving speed of the laser beam by controlling the moving part according to the speed information from the characteristic value input part, and the information about the cutting pattern from the data base.

Another exemplary embodiment of the present invention, there is provided a laser cutting device including: a database that stores information about a cutting pattern, and speed information according to characteristic values of an object to be cut; a moving part that changes a location of a laser beam emitted to the object; a characteristic value measuring part that measures the characteristic values of the object according to locations on the cutting pattern; and a control part that determines moving speeds according to the locations on the cutting pattern by matching the characteristic values measured at the characteristic value measuring part with the speed information stored in the database, and controls the moving part according to the moving speeds to adjust a moving speed of the laser beam.

Another exemplary embodiment of the present invention, there is provided a laser cutting method for a laser cutting device, including: receiving speed information according to locations on a preset cutting pattern; and changing a moving speed of a laser beam emitted to an object to be cut, according to the speed information.

### BRIEF DESCRIPTION OF THE DRAWINGS

FIG. 1 is a view illustrating a configuration of a laser cutting device according to an embodiment of the present invention;

FIG. 2 is a view illustrating a cutting method according to an embodiment of the present invention; and

FIG. 3 is a view illustrating a configuration of a laser cutting device according to an embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. Prior to this, terms or words used in the present specification and claims should not be interpreted as being limited to typical or dictionary meanings, but should be interpreted as having meanings and concepts which comply with the technical spirit of the present invention, based on the principle that an inventor can appropriately define the concept of the term to describe his/her own invention in the best manner. Therefore, configurations illustrated in the embodiments and the drawings described in the present specification are only the most preferred embodiment of the present invention and do not represent all of the technical spirit of the present invention, and thus it is to be understood that various equivalents and modified examples, which may replace the configurations, are possible when filing the present application.

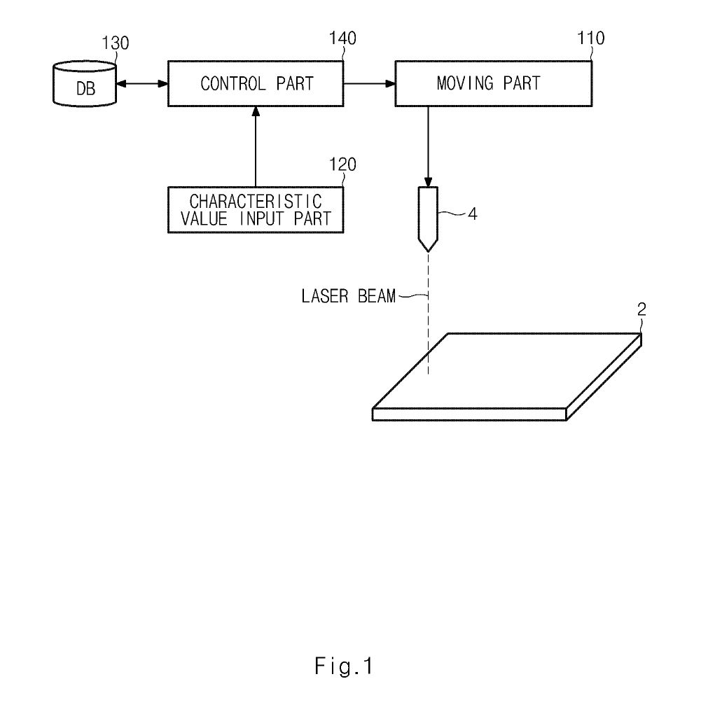

FIG. 1 is a view illustrating a configuration of a laser cutting device according to an embodiment of the present invention.

Referring to FIG. 1, a laser cutting device includes a moving part 110, a characteristic value input part 120, a database 130, and a control part 140.

The moving part 110 moves a laser 4 according to a control of the control part 140, thereby changing (moving) a location of a laser beam emitted to an object 2 to be cut. In particular, the moving part 110 not only changes the location of the laser beam, but also increases or decreases a moving speed of the laser beam according to the control of the control part 140.

The characteristic value input part 120, which is a user interface device including a plurality of input keys, receives speed information from a user according to locations on a preset cutting pattern and transmits the speed information to the control part 140.

The database 130 stores information about the preset cutting pattern. The cutting pattern is a design pattern for an object to be formed (for example, an electrode of a secondary battery). The laser beam cuts the object 2 according to the cutting pattern. The database 130 stores characteristic information of the object 2 according to the locations on the cutting pattern. For example, the database 130 may store information for determining whether the object 2 is coated in the locations on the cutting pattern, and a color of a location in which the object 2 is coated. In particular, the database 130 may store information about absorption coefficient of the object 2 according to the locations on the cutting pattern, as the characteristic information.

The control part 140 adjusts the moving speed of the laser beam by controlling the moving part 110 according to the speed information transmitted from the characteristic value input part 120, and the information about the cutting pattern stored in the database 130. That is, the control part 140 controls the moving part 110 to emit the laser beam according to the cutting pattern, and adjusts the moving speed of the laser beam according to the locations on the cutting pattern and the speed information transmitted from the characteristic value input part 120, without moving the laser beam at the same speed over the whole of the cutting pattern.

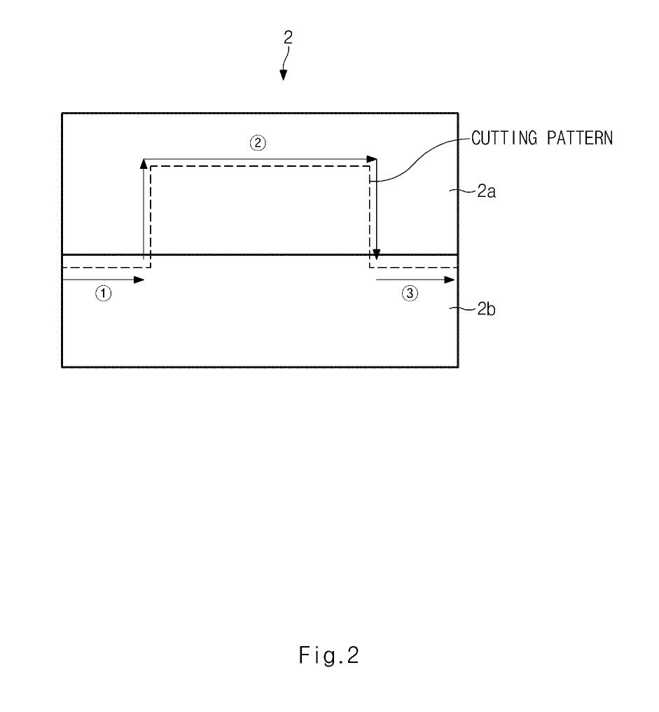

FIG. 2 is a view illustrating a cutting method according to an embodiment of the present invention.

The object 2, which is a material film for forming an electrode of a secondary battery, is divided into a first region 2a constituted by a metal thin film, and a second region 2b constituted by a metal thin film and an active material and having a surface coated with a specific color. Thus, a surface of the first region 2a is different in absorption coefficient from the surface of the second region 2b. That is, the first region 2a has an absorption coefficient smaller than that of the second region 2b. Such information may be stored in the database 130.

Portions \textcircled{1} and \textcircled{3} of the preset cutting pattern are disposed in the second region 2b, and a portion \textcircled{2} of the preset cutting pattern is disposed in the first region 2a, in a design process, as depicted with dotted lines of FIG. 2. Thus, when the preset cutting pattern is entirely cut under the same condition, the portions \textcircled{1} and \textcircled{3} disposed in the second region 2b having the great absorption coefficient are normally cut, but the portion \textcircled{2} disposed in the first region 2a having the small absorption coefficient may be abnormally cut since an energy of the laser beam absorbed in the object 2 corresponding to the portion \textcircled{2} is small. That is, the portion \textcircled{2} may be incompletely cut.

Thus, the user uses the information about the cutting pattern and the characteristic information of the object 2 according to the locations on the cutting pattern, which are stored in the database 130, to determine a section of the cutting pattern disposed in the first region 2a, a section of the cutting pattern disposed in the second region 2b, and the difference between absorption coefficients of the sections. After that, the user uses the characteristic value input part 120 to set different speed values in the locations on the cutting pattern, thereby corresponding to the difference between the absorption coefficients of the first and second regions 2a and 2b.

The control part 140 controls the moving part 110 according to the speed information set by the user such that a moving speed of the laser beam when passing through a portion of the cutting pattern disposed in the first region 2a is lower than a moving speed of the laser beam when passing through a portion of the cutting pattern disposed in the second region 2b. Accordingly, energy is uniformly absorbed in both the portions of the cutting pattern disposed in the first region 2a and the second region 2b.

Thus, all regions of the cutting pattern can be completely cut.

Although only the second region 2b is coated according to the current embodiment, a case in which the first second region 2a and the second region 2b are coated with colors having different absorption coefficients may be applied to the cutting method.

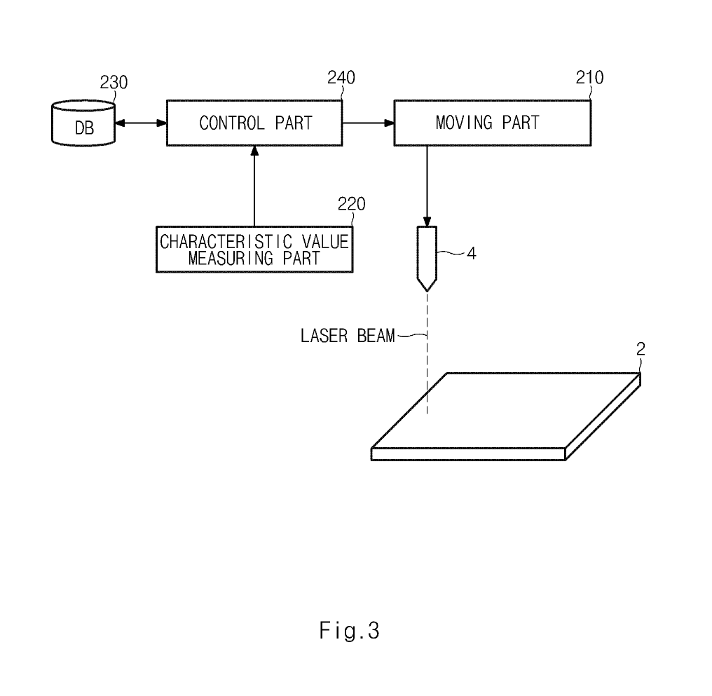

FIG. 3 is a view illustrating a configuration of a laser cutting device according to an embodiment of the present invention.

The user personally inputs the speed information in the embodiment of FIG. 1. However, according to the embodiment of FIG. 3, absorption coefficients of an object to be cut according to locations on a cutting pattern are automatically calculated, and moving speeds of a laser beam are automatically set according to the calculated absorption coefficients.

Referring to FIG. 3, a laser cutting device includes a moving part 210, a characteristic value measuring part 220, a database 230, and a control part 240.

The moving part 210 moves a laser 4 according to a control of the control part 240, thereby changing (moving) a location of a laser beam emitted to an object (2) to be cut, like the embodiment of FIG. 1.

The characteristic value measuring part 220 measures characteristic values of the object 2 according to locations on a cutting pattern, and transmits the measured characteristic values to the control part 240. In this case, the characteristic value measuring part 220 may measure absorption coefficients as the characteristic values.

For example, before a cutting process, the characteristic value measuring part 220 emits a scanning laser beam to the object 2 according to the cutting pattern, and receives a laser beam reflected from the object 2 according to the emitting of the scanning laser beam. After that, the characteristic value measuring part 220 compares amounts of light of the received laser beam with amounts of light of the emitted scanning laser beam according to the locations on the cutting pattern, thereby measuring the absorption coefficients of the object 2 according to the locations on the cutting pattern. Alternatively, before the cutting process, the characteristic value measuring part 220 emits the scanning laser beam to the object 2 according to the cutting pattern, and receives a laser beam passed through the object 2 according to the emitting of the scanning laser beam. After that, the characteristic value measuring part 220 compares intensities of light of the passed through laser beam with intensities of light of the emitted scanning laser beam, thereby measuring the absorption coefficients of the object 2 according to the locations on the cutting pattern. When an absorption coefficient of an object to which light passes, a propagation distance, and intensities of the light before and after propagating over the propagation distance are denoted by a(cm⁻¹), x(cm), I₀, and I, respectively, a formula I=I₀e^{-ax} may be defined, wherein Fresnel reflection on a surface of the object is neglected.

Thus, when an intensity of light of an emitted laser beam, and an intensity of light of a laser beam passed through an object are known, an absorption coefficient of the object is determined.

The database 230 stores information about the cutting pattern, and speed information according to absorption coefficients. For example, the database 230 may store a table of speed information, pieces of which correspond to the absorption coefficients, respectively. The speed information may be classified according to wavelengths of used laser beams and be stored.

A cutting method will now be described with reference to FIGS. 2 and 3.

Before laser cutting, the characteristic value measuring part 220 emits the scanning laser beam according to the cutting pattern depicted with the dotted line of FIG. 2, and receives the laser beam reflected from the object 2 according to the cutting pattern or the laser beam passed through the object 2.

Next, the characteristic value measuring part 220 calculates the absorption coefficients of the object 2 according to the locations on the cutting pattern by using the emitted laser beam and the received laser beam. For example, the characteristic value measuring part 220 measures the absorption coefficients of the object 2 according to the locations on the cutting pattern by comparing an amount of light of the emitted laser beam with an amount of light of the received laser beam or comparing an intensity of light of the emitted laser beam with an intensity of light of the passed through laser beam. The measured absorption coefficients are transmitted to the control part 240. That is, the absorption coefficients corresponding to the portions \textcircled{1}, \textcircled{2}, and \textcircled{3} of the cutting pattern are transmitted to the control part 240.

The control part 240 uses the absorption coefficients according to the locations on the cutting pattern transmitted from the characteristic value measuring part 220, to search for the speed information corresponding to the absorption coefficients in the database 230. Accordingly, speed values corresponding to the portions \textcircled{1}, \textcircled{2}, and \textcircled{3} of the cutting pattern are determined. {}

The control part 240 controls the moving part 210 according to the determined speed values such that a moving speed of the laser beam when passing through a portion of the cutting pattern disposed in the first region 2a is lower than a moving speed of the laser beam when passing through a portion of the cutting pattern disposed in the second region 2b. Accordingly, energy is uniformly absorbed in both the portions of the cutting pattern disposed in the first region 2a and the second region 2b.

Thus, all regions of the cutting pattern can be completely cut.

While the foregoing preferred embodiments of the present invention have been exemplified, it will be understood by those of ordinary skill in the art that various modifications, changes, replacements, and additions could be made therein without departing from the technical spirit and scope of the present invention as defined by the following claims.

For example, instead of moving the laser 4 by means of the moving parts 110 and 210 as illustrated in FIGS. 1 and 3, a shelf on which the object 2 is placed may be moved to change the location of the laser beam emitted to the object 2.

According to the embodiments of the present invention, even when an object to be cut includes regions having different characteristics, the object can be completely cut.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

What is claimed is:

1. A laser cutting device comprising:
a database that stores information about a cutting pattern;
a moving part that changes a location of a laser beam emitted to an object to be cut;
a characteristic value input part that receives speed information from a user according to locations on the cutting pattern; and
a control part that adjusts a moving speed of the laser beam by controlling the moving part according to the speed information from the characteristic value input part, and the information about the cutting pattern from the data base.

2. The laser cutting device of claim 1, wherein the database stores characteristic information of the object according to the locations on the cutting pattern.

3. The laser cutting device of claim 2, wherein the database stores information about absorption coefficients of the object according to the locations on the cutting pattern.

4. The laser cutting device of claim 1, wherein the moving part moves a laser emitting the laser beam.

5. The laser cutting device of claim 1, wherein the moving part moves a shelf on which the object is placed.

6. A laser cutting device comprising:
a database that stores information about a cutting pattern, and speed information according to characteristic values of an object to be cut;
a moving part that changes a location of a laser beam emitted to the object;
a characteristic value measuring part that measures the characteristic values of the object according to locations on the cutting pattern; and
a control part that determines moving speeds according to the locations on the cutting pattern by matching the characteristic values measured at the characteristic value measuring part with the speed information stored in the database, and controls the moving part according to the moving speeds to adjust a moving speed of the laser beam.

7. The laser cutting device of claim 6, wherein the characteristic value measuring part measures absorption coefficients of the object according to the locations on the cutting pattern.

8. The laser cutting device of claim 7, wherein the characteristic value measuring part emits a scanning laser beam to the object according to the cutting pattern, and then, compares amounts of light of the scanning laser beam with amounts of light of a reflected laser beam according to the locations on the cutting pattern, thereby measuring the absorption coefficients of the object according to the locations on the cutting pattern.

9. The laser cutting device of claim 7, wherein the characteristic value measuring part emits a scanning laser beam to the object according to the cutting pattern, and then, uses intensities of light of the scanning laser beam and intensities of light of a laser beam passed through the object, thereby measuring the absorption coefficients of the object according to the locations on the cutting pattern.

10. The laser cutting device of claim 6, wherein the moving part moves a laser for emitting the laser beam.

11. The laser cutting device of claim 6, wherein the moving part moves a shelf on which the object is placed.

12. A laser cutting method for a laser cutting device, comprising:
receiving speed information according to locations on a preset cutting pattern; and
changing a moving speed of a laser beam emitted to an object to be cut, according to the speed information.

13. The laser cutting method of claim 12, wherein the speed information according to the locations on the preset cutting pattern includes speed values that are different according to absorption coefficients of the object and the locations on the preset cutting pattern.

14. The laser cutting method of claim 13, wherein the absorption coefficients are measured by emitting a scanning laser beam to the object according to the cutting pattern, and then, comparing amounts of light of the scanning laser beam with amounts of light of a reflected laser beam according to the locations on the cutting pattern.

15. The laser cutting method of claim 13, wherein the absorption coefficients are measured by emitting a scanning laser beam to the object according to the cutting pattern, and then, using intensities of light of the scanning laser beam and intensities of light of a laser beam passed through the object.
